(19) United States
(12) Patent Application Publication
(10) Pub. No.: US 2025/0203582 A1
(43) Pub. Date: Jun. 19, 2025

(54) METHOD FOR DETERMINING RESOURCE ALLOCATION MODE, TERMINAL DEVICE, AND NETWORK DEVICE

(71) Applicant: GUANGDONG OPPO MOBILE TELECOMMUNICATIONS CORP., LTD., Dongguan (CN)

(72) Inventor: Zhongda DU, Dongguan (CN)

(73) Assignee: GUANGDONG OPPO MOBILE TELECOMMUNICATIONS CORP., LTD., Dongguan (CN)

(21) Appl. No.: 19/071,097

(22) Filed: Mar. 5, 2025

Related U.S. Application Data
(63) Continuation of application No. PCT/CN2022/117892, filed on Sep. 8, 2022.

(51) Int. Cl. H04W 72/02; H04W 72/52; H04W 72/54; H04W 92/18

(52) U.S. Cl. CPC H04W 72/02; H04W 72/52; H04W 72/54; H04W 92/18

(57) ABSTRACT

A method for determining a resource allocation mode, a terminal device, and a network device are provided. The method includes: determining, by a terminal device, a first resource allocation mode from a plurality of resource allocation modes, where the plurality of resource allocation modes include a mode of resource scheduling by a network device and a mode of independent resource selection by the terminal device.

### CROSS-REFERENCE TO RELATED APPLICATIONS

This application is a continuation of International Application No. PCT/CN2022/117892, filed on Sep. 8, 2022, the disclosure of which is hereby incorporated by reference in its entirety.

### TECHNICAL FIELD

This application relates to the field of communications technologies, and more specifically, to a method for determining a resource allocation mode, a terminal device, and a network device.

### RELATED ART

With the development of wireless communications technologies, users have an increasing demand on a higher transmission rate and a larger bandwidth. To meet demands of users, a wireless communications system operates on increasingly high spectrum, while coverage of a network is reduced accordingly, resulting in that the number of users sharing a large bandwidth within the coverage of the network declines.

### SUMMARY

This application provides a method for determining a resource allocation mode, a terminal device, and a network device. The following describes the aspects related to this application.

According to a first aspect, a method for determining a resource allocation mode is provided. The method includes: determining, by a terminal device, a first resource allocation mode from a plurality of resource allocation modes, where the plurality of resource allocation modes include a mode of resource scheduling by a network device and a mode of independent resource selection by the terminal device.

According to a third aspect, a terminal device is provided. The terminal device includes: a memory and a processor, where the memory is configured to store computer programs, and the processor is configured to execute the computer programs stored in the memory to cause the terminal device to perform an operation of: determining a first resource allocation mode from a plurality of resource allocation modes, where the plurality of resource allocation modes include a mode of resource scheduling by a network device and a mode of independent resource selection by the terminal device.

According to a fourth aspect, a network device is provided. The network device includes: a memory and a processor, wherein the memory is configured to store computer programs, and the processor is configured to execute the computer programs stored in the memory to cause the terminal device to perform an operation of: transmitting assistance information to a terminal device, where the assistance information is used for the terminal device to determine a first resource allocation mode from a plurality of resource allocation modes, where the plurality of resource allocation modes include a mode of resource scheduling by a network device and a mode of independent resource selection by the terminal device.

### BRIEF DESCRIPTION OF DRAWINGS

FIG. 1 is an example diagram of a system architecture of a wireless communications system to which embodiments of this application are applicable.

FIG. 2 is an example diagram of a scenario of sidelink communication within network coverage.

FIG. 3 is an example diagram of a scenario of sidelink communication based on partial network coverage.

FIG. 4 is an example diagram of a scenario of sidelink communication outside network coverage.

FIG. 5 is a schematic flowchart of a method for determining a resource allocation manner according to an embodiment of this application.

FIG. 6 is a schematic flowchart of a method for determining a resource allocation mode according to another embodiment of this application.

FIG. 7 is a schematic flowchart of a method for determining a resource allocation mode according to still another embodiment of this application.

FIG. 8 is a schematic flowchart of a method for determining a resource allocation mode according to still another embodiment of this application.

FIG. 9 is a schematic structural diagram of a terminal device according to an embodiment of this application.

FIG. 10 is a schematic structural diagram of a network device according to an embodiment of this application.

FIG. 11 is a schematic structural diagram of a communications apparatus according to an embodiment of this application.

### DESCRIPTION OF EMBODIMENTS

### Communications System Architecture

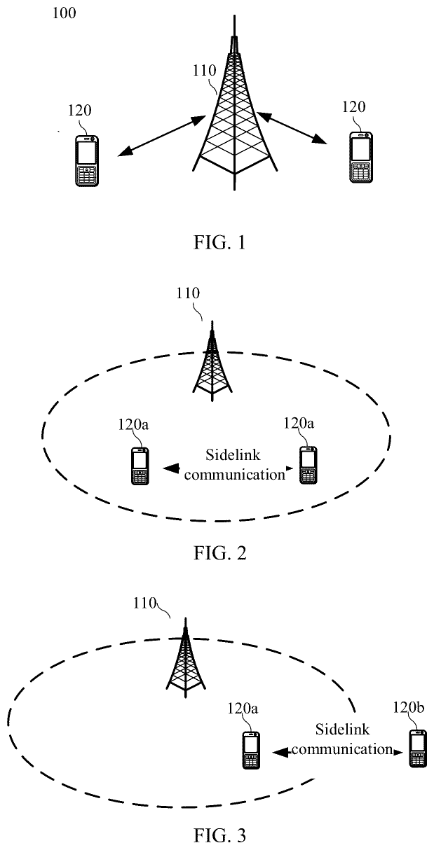

How to improve performance of a wireless communications system has become a problem that needs to be resolved. FIG. 1 is an example diagram of a system architecture of a wireless communications system 100 to which an embodiment of this application is applicable. The wireless communications system 100 may include a network device 110 and terminal devices 120. The network device 110 may be a device that communicates with the terminal device 120. The network device 110 may provide communication coverage for a specific geographic area, and may communicate with the terminal device 120 located within the coverage.

FIG. 1 shows one network device and two terminal devices as an example. Optionally, the wireless communications system 100 may include one or more network devices 110, and/or another quantity of terminal devices 120. For a network device 110, the one or more terminal devices 120 may be located within network coverage of the network device 110, or may be located outside network coverage of the network device 110, or may be located partially within the network coverage of the network device 110, and may be located partially outside the network coverage of the network device 110, which is not limited in embodiments of this application.

Optionally, the wireless communications system 100 may further include another network entity such as a network controller or a mobility management entity, which is not limited in embodiments of this application.

It should be understood that the wireless communications system 100 further includes a core network portion, or in other words, the wireless communications system 100 may include a terminal device, a network device, and a core network. The core network may be connected to one or more network devices, one or more terminal devices may communicate with each other under the network device. For example, one or more terminal devices may communicate with each other under a same network device.

In some implementations, one network device may further include one or more cells. In a case in which the network device includes a plurality of cells, one or more terminal devices within a same cell may share resources within the cell.

It should be understood that the technical solutions in embodiments of this application may be applied to various communications systems, such as a 5th generation (5G) system or new radio (NR), a long-term evolution (LTE) system, an LTE frequency division duplex (FDD) system, and LTE time division duplex (TDD). The technical solutions provided in this application may be further applied to a future communications system, such as a 6th generation mobile communications system or a satellite communications system.

The terminal device in embodiments of this application may also be referred to as user equipment (UE), an access terminal, a subscriber unit, a subscriber station, a mobile site, a mobile station (MS), a mobile terminal (MT), a remote station, a remote terminal, a mobile device, a user terminal, a terminal, a wireless communications device, a user agent, or a user apparatus. The terminal device in embodiments of this application may be a device providing a user with voice and/or data connectivity and capable of connecting people, objects, and machines, such as a handheld device or a vehicle-mounted device having a wireless connection function. The terminal device in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, or the like. Optionally, the UE may be configured to function as a base station. For example, the UE may function as a scheduling entity, which provides a sidelink signal between UEs in V2X, D2D, or the like. For example, a cellular phone and a vehicle communicate with each other through a sidelink signal. A cellular phone and a smart home device communicate with each other, without relaying a communication signal through a base station.

The network device in embodiments of this application may be a device configured to communicate with the terminal device. The network device may also be referred to as an access network device or a radio access network device. For example, the network device may be a base station. The network device in embodiments of this application may be a radio access network (RAN) node (or device) that connects the terminal device to a wireless network. The base station may broadly cover various names below, or may be replaced with the following names, such as a NodeB, an evolved NodeB (eNB), a next generation NodeB (gNB), a relay station, an access point, a transmitting and receiving point (TRP), a transmitting point (TP), a master MeNB, a secondary SeNB, a multi-standard radio (MSR) node, a home base station, a network controller, an access node, a wireless node, an access point (AP), a transmission node, a transceiver node, a base band unit (BBU), a remote radio unit (RRU), an active antenna unit (AAU), a remote radio head (RRH), a central unit (CU), a distributed unit (DU), and a positioning node. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in device-to-device D2D, vehicle-to-everything (V2X), and machine-to-machine (M2M) communication, a network-side device in a 6G network, a device that functions as a base station in a future communications system, or the like. The base station may support networks with a same access technology or different access technologies. A specific technology and a specific device form used by the network device are not limited in embodiments of this application.

The base station may be stationary or mobile. For example, a helicopter or an unmanned aerial vehicle may be configured to function as a mobile base station, and one or more cells may move according to a location of the mobile base station. In other examples, a helicopter or an unmanned aerial vehicle may be configured to function as a device that communicates with another base station.

In some deployments, the network device in embodiments of this application may be a CU or a DU, or the network device includes a CU and a DU. The gNB may further include an AAU.

The network device and the terminal device may be deployed on land, including being deployed indoors or outdoors, handheld, or vehicle-mounted, may be deployed on a water surface, or may be deployed on a plane, a balloon, or a satellite in the air. In embodiments of this application, a scenario in which the network device and the terminal device are located is not limited.

It should be understood that all or some of functions of a communications device in this application may also be implemented by software functions running on hardware, or by virtualization functions instantiated on a platform (for example, a cloud platform).

### Sidelink Communication in Different Network Coverage

Sidelink communication refers to a sidelink-based communication technology. Sidelink communication may be, for example, D2D or V2X. Communication data in a conventional cellular system is received or transmitted between a terminal device and a network device, while sidelink communication supports direct communication data transmission between terminal devices. Compared with conventional cellular communication, direct transmission of communication data between terminal devices may realize higher spectral efficiency and a lower transmission delay. For example, an Internet of vehicles system uses a sidelink communication technology.

Sidelink communication may be classified, depending on a network coverage status of the terminal device, into sidelink communication within network coverage, sidelink communication based on partial network coverage, and sidelink communication outside network coverage.

FIG. 2 is an example diagram of a scenario of sidelink communication within network coverage. In the scenario shown in FIG. 2, two terminal devices 120a are both located within coverage of a network device 110. Therefore, both the two terminal devices 120a may receive configuration signalling (where the configuration signalling in this application may be replaced with configuration information) from the network device 110, and determine a sidelink configuration based on the configuration signalling from the network device 110. After performing sidelink configuration, both the two terminal devices 120a may perform sidelink communication on a sidelink.

FIG. 3 is an example diagram of a scenario of sidelink communication based on partial network coverage. In the scenario shown in FIG. 3, a terminal device 120a performs sidelink communication with a terminal device 120b. The terminal device 120a is located within coverage of a network device 110. Therefore, the terminal device 120a can receive configuration signalling from the network device 110, and determine a sidelink configuration based on the configuration signalling from the network device 110. The terminal device 120b is located outside network coverage, and cannot receive the configuration signalling from the network device 110. In this case, the terminal device 120b may determine a sidelink configuration based on pre-configuration information and/or information that is carried on a physical sidelink broadcast channel (PSBCH) transmitted by the terminal device 120a located within the network coverage. After performing sidelink configuration, both the terminal device 120a and the terminal device 120b may perform sidelink communication on a sidelink.

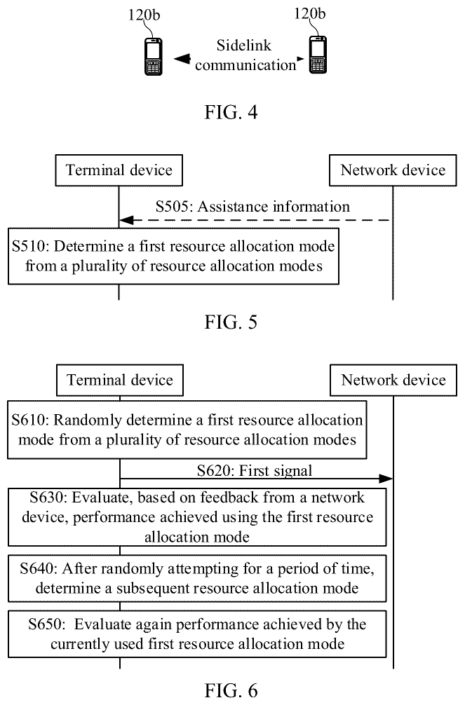

FIG. 4 is an example diagram of a scenario of sidelink communication outside network coverage. In the scenario shown in FIG. 4, two terminal devices 120b are both located outside network coverage. In this case, both the two terminal devices 120b may determine a sidelink configuration based on pre-configuration information. After performing sidelink configuration, both the two terminal devices 120b may perform sidelink communication on a sidelink.

### Resource Allocation Mode in a Communications System

In some standards or protocols (for example, 3rd generation partnership project (3rd Generation Partnership Project, 3GPP)), a plurality of resource allocation modes are defined, such as a plurality of resource allocation modes corresponding to uplink and downlink communication, and a plurality of resource allocation modes corresponding to sidelink communication.

In a scenario of uplink and downlink communication (communication between a terminal device and a network device), before transmitting an uplink signal via a Uu interface, a terminal device typically determines (or selects) a resource (the resource mentioned in this application may also be referred to as a radio resource or a transmission resource, for example, a time-frequency resource) for transmitting the uplink signal from resources scheduled by a network device, that is, the resource for transmitting the uplink signal is scheduled by the network device, or it may be understood that the resource is allocated by the network device. Application scenarios where a terminal device can independently select resources are limited. The terminal device can determine a random access resource by independent selection in only a scenario of random access. For example, in a four-step random access manner, the terminal device may independently select a resource for carrying a random access preamble. Alternatively, in a two-step random access manner, the terminal device may independently select a resource for carrying a preamble and a physical uplink shared channel (physical uplink shared channel, PUSCH).

In some implementations, a mode of resource scheduling by a network device may include a mode of dynamically scheduling a resource by the network device to the terminal device (referred to as a dynamic scheduling mode). In an uplink direction, full dynamic scheduling is generally triggered by a terminal device. For example, in a current 5G system, the terminal device may transmit a scheduling request to the network device, and the network device may transmit a scheduling grant to the terminal device, so that the terminal device can transmit an uplink signal based on the scheduling grant. Dynamically scheduling a resource by a network device to a terminal device can generate the following benefit effects. Once the network device transmits a scheduling grant to the terminal device, a resource associated with the scheduling grant is used only by the terminal device to which the resource is scheduled, thereby avoiding a problem of resource conflicts between different terminal devices. However, this manner also has disadvantages, such as introducing an excessive delay in the user plane.

In some implementations, a mode of resource scheduling by a network device may include a mode of pre-configuring a resource by the network device for the terminal device (referred to as a pre-configuration based resource allocation mode). In the uplink direction, the network device may pre-configure some resources for the terminal device, and the terminal device may transmit an uplink signal using the pre-configured resources. Compared with the dynamic scheduling mode, the pre-configuration based resource allocation mode can reduce a delay in the user plane. However, there is not always uplink data to be transmitted, resulting in waste of resources not used among the pre-configured resources.

In some standards or protocols (for example, 3GPP), two resource allocation modes for sidelink communication (or referred to as modes of sidelink communication, or transmission modes of sidelink communication) are defined: a first mode and a second mode.

In the first mode, a resource for a terminal device is scheduled by a network device. The terminal device may transmit data on a sidelink using the resource scheduled by the network device. The network device may schedule a resource for a single transmission to the terminal device, or may allocate a resource for semi-persistent transmission to the terminal device. The first mode may be applied to a scenario in which there is coverage of the network device, for example, the scenario shown in FIG. 2 above. In the scenario shown in FIG. 2, the terminal device 120a is located within the network coverage of the network device 110. Therefore, the network device 110 may allocate, to the terminal device 120a, a resource to be used in a sidelink transmission process.

In the second mode, the terminal device may independently select one or more resources from a resource pool (resource pool, RP). Then, the terminal device may perform sidelink transmission by using the selected resource. For example, in the scenario shown in FIG. 4, the terminal device 120b is located outside the cell coverage. Therefore, the terminal device 120b may independently select a resource from a resource pool to perform sidelink transmission.

In a scenario of sidelink communication, before transmitting a sidelink signal via a PC5 interface, the terminal device may determine, using the first mode or the second mode, a resource for transmitting the sidelink signal.

Regardless of whether in the scenario of uplink and downlink communication or in the scenario of sidelink communication, although there are a plurality of resource allocation modes, a resource allocation mode used for determining a resource for carrying a wireless signal (such as an uplink signal, or a sidelink signal) is specified in a protocol or determined by the network device, and the terminal device has no right to determine (decide) the mode independently. In other words, for a wireless signal to be transmitted, whether a resource for carrying the wireless signal should be scheduled by the network device or independently selected by the terminal device is specified in a protocol or determined by the network device, and the terminal device cannot decide the mode independently.

For example, in the scenario of uplink and downlink communication, it is specified in a protocol that a random access resource may be independently selected by the terminal device, and a resource for transmitting another signal by the terminal device may be scheduled by the network device. The terminal device cannot decide whether a resource for carrying a signal is scheduled by the network device or independently selected by the terminal device.

For example, in the scenario of sidelink communication, whether the terminal device uses the first mode or the second mode to select a sidelink resource is specified in a protocol or a network. For example, if the terminal device is located outside coverage of the network, the terminal device can use only the second mode to select a sidelink resource. The terminal device cannot decide whether a resource for carrying a signal is scheduled by the network device or independently selected by the terminal device.

The technology described above is based on a fact that a cellular network has a large coverage, generally spanning over a hundred meters, and there are generally at least dozens of users within a single cell. With the development of wireless communications technologies, users have an increasing demand on a higher transmission rate and a larger bandwidth. To meet demands of users, a wireless communications system operates on increasingly high spectrum and in an increasingly large bandwidth, while coverage of a network is reduced accordingly, resulting in that the number of users sharing a large bandwidth within the coverage of the network declines. For example, in a future Terahertz cellular network, there may be only a few users in each cell, and a large bandwidth within coverage of the network is shared by only the few users. In this case, how to improve performance of a wireless communications system has become a problem that needs to be resolved.

To resolve the foregoing problems, an embodiment of this application provides a solution for determining a resource allocation mode, to improve performance of a wireless communications system.

FIG. 5 is a schematic flowchart of a method for determining a resource allocation mode according to an embodiment of this application. The method shown in FIG. 5 is described from a perspective of interaction between a terminal device and a network device. The terminal device and the network device may be, for example, a terminal device 120 and a network device 110 shown in FIG. 1 to FIG. 4. The method illustrated in FIG. 5 may include step S510. The following describes the step in detail.

In step S510, a terminal device determines a first resource allocation mode from a plurality of resource allocation modes.

A resource may be used to carry uplink and downlink signals between a terminal device and a network device, or may be used to carry a sidelink signal between terminal devices.

A resource may be accessed using multiple access methods across various dimensions, such as in time domain, frequency domain, and code domain. Accordingly, a resource may refer to a time domain resource, a frequency domain resource, a code domain resource, or the like. A type of resource is not specifically limited in embodiments of this application.

When the terminal device transmits an uplink signal to the network device or transmits a sidelink signal to another terminal device, a resource for carrying the uplink signal or the sidelink signal is obtained using a specific resource allocation mode.

Resources may be allocated to the terminal device by a plurality of modes, which are not limited in embodiments of this application. For example, the plurality of resource allocation modes may include a mode of resource scheduling by a network device and a mode of independent resource selection by the terminal device.

The mode of resource scheduling by a network device may refer to that a resource for transmitting a wireless signal (for example, an uplink signal or a sidelink signal) is scheduled by the network device. The terminal device may transmit an uplink signal on an uplink or transmit a sidelink signal on a sidelink using the resource scheduled by the network device.

The mode of independent resource selection by the terminal device may refer to that a resource for transmitting a wireless signal is independently selected by the terminal device from a resource pool. Alternatively, a resource determined using the mode of independent resource selection by the terminal device is selected by the terminal device from a resource pool. The terminal device may transmit an uplink signal on an uplink or transmit a sidelink signal on a sidelink using the independently selected resource.

In some embodiments, independently selecting a resource by the terminal device may refer to independently selecting a resource by the terminal device for the terminal device itself. In some embodiments, independently selecting a resource by the terminal device may refer to independently selecting a resource by the terminal device for another terminal device (for example, another terminal device that performs sidelink communication with the terminal device).

The first resource allocation mode is determined by the terminal device from the plurality of resource allocation modes mentioned above. After determining the first resource allocation mode, the terminal device may determine, using the first resource allocation mode, a resource for transmitting a wireless signal. In other words, the terminal device may determine (or select) a resource allocation mode for selecting a resource for carrying a wireless signal.

For example, the terminal device may determine that the first resource allocation mode is the mode of resource scheduling by a network device, that is, the terminal device may select a resource by using the mode of resource scheduling by a network device. Alternatively, the terminal device may determine that the first resource allocation mode is the mode of independent resource selection by the terminal device, that is, the terminal device may select a resource by using the mode of independent resource selection by the terminal device, to transmit a wireless signal using the selected resource.

In embodiments of this application, the terminal device can determine a first resource allocation mode from a plurality of resource allocation modes. In other words, the terminal device has a capability to independently determine a resource allocation mode, such that the terminal device can select resources using different resource allocation modes depending on different situations, thereby improving resource selection flexibility, and thus improving performance of a wireless communications system.

In some embodiments, in a case in which the terminal device determines that the first resource allocation mode is the mode of resource scheduling by a network device, the terminal device may request the network device to schedule resources using a pre-configured wireless channel (for example, an uplink control channel). After receiving a scheduling grant transmitted by the network device, the terminal device may transmit a wireless signal on a resource included in the scheduling grant. In some embodiments, a manner of transmitting a wireless signal on the resource may also be specified in the scheduling grant. In this case, the terminal device may transmit a wireless signal on the resource in the manner specified in the scheduling grant, for example, transmit an uplink signal or a sidelink signal.

In some embodiments, in a case in which a resource for carrying a wireless signal is determined using the mode of resource scheduling by a network device, the terminal device may transmit information currently cached by the terminal device to the network device, to trigger a subsequent scheduling grant. For example, when transmitting an uplink signal using the resource indicated by the scheduling grant, the terminal device may include the currently cached information in the uplink signal. Alternatively, when transmitting a sidelink signal using the resource indicated by the scheduling grant, the terminal device may transmit the currently cached information individually to the network device, or may carry the currently cached information in another signal for transmission.

Resources may be scheduled by a network device by using a plurality of manners, which are not limited in embodiments of this application. For example, the mode of resource scheduling by a network device may include a dynamic scheduling mode and/or a semi-persistent scheduling mode. In the dynamic scheduling mode, for each data packet from the terminal device, the network device notifies the terminal device of a resource to be occupied by the data packet and a transmission manner of the data packet, by using respective downlink control signalling. In the semi-persistent scheduling mode, the network device transmits downlink control signalling when initiating semi-persistent transmission. The terminal device starts semi-persistent transmission using a resource indicated by the downlink control signalling. The terminal device transmits and receives data packets at a specific period, until another downlink control signalling in a specific format is received.

Embodiments of this application are not limited thereto. In some embodiments, the mode of resource scheduling by a network device may further include a pre-configuration based resource allocation mode, or the like, as long as a resource for carrying a wireless signal to be transmitted by the terminal device is scheduled by the network device.

In some embodiments, in a case in which the terminal device determines that the first resource allocation mode is the mode of independent resource selection by the terminal device, the terminal device may randomly select, from a resource pool, a resource for transmitting a wireless signal. For example, if the terminal device has a listening capability, the terminal device may acquire a set of available resources from the resource pool through listening, and then randomly select a resource from the set for transmitting a wireless signal. If the terminal device does not have a listening capability, the terminal device may directly randomly select a resource from the resource pool for transmitting a wireless signal.

A source of the resource pool is not specifically limited in embodiments of this application. In some embodiments, the resource pool may be pre-configured for the terminal device. In some embodiments, the resource pool may be configured and broadcasted by the network device. In this case, it may be understood that the terminal device may select a required resource from a resource pool specified by the network device. In a specific implementation, the network device may notify, using public or dedicated signalling, the terminal device of specific resources from which the terminal device is allowed to independently select a resource for transmitting a wireless signal.

In some embodiments, when notifying, using public or dedicated signalling, the terminal device of information related to the resource pool, the network device may further include, in the siganlling, some parameters for transmitting data. These parameters may be one or more sets of parameters, and a combination thereof, such as power control parameters, modulation parameters, and channel numbering parameters. The terminal device may select some of these parameters, for example, may select, depending on specific situations, some parameters that the network device allows the terminal device to independently decide.

In some embodiments, after determining the first resource allocation mode, the terminal device may select a first resource using the first resource allocation mode, and transmit a first signal using the first resource.

In some embodiments, resources determined using the first resource allocation mode may include an uplink communication resource (that is, the first resource is an uplink communication resource). In this case, the first signal transmitted using the first resource may be an uplink signal.

In some embodiments, resources determined using the first resource allocation mode may include a sidelink communication resource (that is, the first resource is a sidelink communication resource). In this case, the first signal transmitted using the first resource may be a sidelink signal.

In some embodiments, the first signal may be retransmitted in a hybrid automatic retransmission request (HARQ) manner.

In some embodiments, in a case in which the first signal is retransmitted in the HARQ manner, a resource allocation mode for retransmitting the first signal may be the same as a resource allocation mode for a previous transmission of the first signal. In some embodiments, a resource allocation mode for retransmitting the first signal may be different from a resource allocation mode for a previous transmission of the first signal. For example, the resource allocation mode for retransmitting the first signal may be the same as or different from a resource allocation mode for an initial transmission of the first signal, or may be the same as or different from a resource allocation mode for a previous transmission of the first signal.

Since there are the plurality of resource allocation modes above, how to determine the first resource allocation mode from the plurality of resource allocation modes by the terminal device becomes a problem to be further discussed. Therefore, in technical solutions provided in embodiments of this application, the terminal device may determine the first resource allocation mode based on first information, or may randomly select the first resource allocation mode, which is described below in detail in combination with specific embodiments.

### Embodiment 1: The First Resource Allocation Mode is Determined by the Terminal Device Based on First Information

Specific content of the first information is not limited in embodiments of this application. For example, the first information may include local information of the terminal device and/or assistance information obtained by the terminal device. The local information of the terminal device may refer to internal information of the terminal device, for example, information that the terminal device can access internally, or information stored in the terminal device. The assistance information obtained by the terminal device may refer to information obtained by the terminal device from external sources, for example, may include assistance information obtained by the terminal device through measurement, assistance information provided by the network device to the terminal device, or assistance information provided by another terminal device.

In some embodiments, the local information of the terminal device may include information related to a data packet at an application layer of the terminal device, for example, may include a size of a data packet to be transmitted at the application layer, a success rate of a previous data packet transmission, and quality of service (QoS) parameters required for a data packet, such as an allowed delay budget, a packet error rate (a ratio of a quantity of discarded data packets to a total quantity of data packets), reliability, and other information. As described above, in some embodiments, in a case in which the network device specifies some transmission parameters by using public or dedicated signalling, the terminal device may alternatively determine, based on the local information above, specific parameters for transmitting a data packet, such as a power, and a bandwidth.

In some embodiments, the assistance information obtained by the terminal device may include information related to a channel where a resource selectable by the terminal device through measurement is located, distribution information of loads within a same cell (or network device), and other related information that may be used to determine the first resource allocation mode.

For example, the first information may include one or more of the following information: assistance information provided by the network device; a measurement result of the terminal device on a first channel, where the first channel is a channel where a resource selectable by the terminal device is located; a status of a load of a cell where the terminal device is located; or a performance evaluation result for a historical resource allocation mode used by the terminal device.

In some embodiments, one or more of the assistance information may be obtained by the terminal device through measurement, so that the terminal device senses congestion of resources in a cell based on measurement of the channel. For example, the first information may include a measurement result of the terminal device on a first channel, where the first channel is a channel where a resource selectable by the terminal device is located. In other words, the terminal device may determine the first resource allocation mode based on the measurement result of the terminal device on the first channel. In an implementation, if the measurement result indicates that a channel occupancy rate of the first channel is greater than a first threshold, the terminal device determines that the first resource allocation mode is the mode of resource scheduling by a network device; or if the measurement result indicates that a channel occupancy rate of the first channel is less than or equal to the first threshold, the terminal device determines that the first resource allocation mode is a mode of independent resource selection by the terminal device. The channel occupancy rate may refer to a ratio at which the channel is occupied within a given time period. For example, if the terminal device measures the channel in 10 slots and obtains a bandwidth occupancy rate of the channel in each of the 10 slots, the channel occupancy rate may be an average value of bandwidth occupancy rates of the channel in the 10 slots.

However, this application is not limited thereto. In some embodiments, after obtaining the measurement result, the terminal device may use the measurement result and other related information (collectively referred to as the first information) that may be used to determine the first resource allocation mode, as input parameters for an artificial intelligence algorithm, so as to determine the first resource allocation mode from the plurality of resource allocation modes by using the artificial intelligence algorithm.

In some embodiments, measurement performed by the terminal device on the first channel may include pre-measurement performed before transmitting a wireless signal (measurement performed before a time instant when transmitting a signal) and current measurement performed when transmitting a signal (measurement performed at a time instant when transmitting a signal). The terminal device performs measurement at a current instant when transmitting a signal, so that the terminal device can determine whether a resource conflict occurs between the terminal device and another terminal device. If no signal transmitted by another terminal device is detected, it may indicate to some extent that there is no resource conflict, or another terminal device that has a conflict with the terminal device is far away from the terminal device.

In some embodiments, if the terminal device detects a severe resource conflict by measurement performed at a time instant when transmitting a signal, the terminal device may choose to retransmit the signal in a timely manner, thereby reducing a delay in retransmission of the wireless signal.

In some embodiments, the terminal device may choose to perform measurement on a full bandwidth of the network device, to improve measurement accuracy. In some embodiments, the terminal device may choose to perform measurement on a partial bandwidth of the network device, to save resources.

In some embodiments, the measurement result of the terminal device on the first channel may include: whether there is another terminal device transmitting a signal on the first channel. However, embodiments of this application are not limited thereto. In some embodiments, the measurement result of the terminal device on the first channel may further include: a strength, direction, and frequency of received signals. By measuring a strength, a direction, and a frequency of a wireless signal from another terminal device, the terminal device may substantially determine a congestion level of a cell (or network device) where the terminal device is located, including a position and a distance of the terminal device relative to the another terminal device, thereby being beneficial for the terminal device to select the first resource allocation mode from the plurality of resource allocation modes. In some embodiments, as long as there two terminal devices can be sufficiently distinguished from each other in a dimension of a direction, the network device may easily distinguish the terminal devices in other dimensions, such as beams of wireless signals.

Considering that continuous measurement of a surrounding environment by the terminal device may result in high power consumption of the terminal device, in some embodiments, one or more of assistance information may be provided by the network device. This is because terminal devices that share resources may transmit wireless signals to the same network device (or cell), such that the network device can collect transmission status of the terminal devices that share resources, such as transmission bandwidths, power, and positions. In this way, the network device may directly provide these assistance information to the terminal device, so that the terminal device determines the first resource allocation mode from the plurality of resource allocation modes by using these assistance information.

Continuing to refer to FIG. 5, in the method illustrated in FIG. 5, before the terminal device determines the first resource allocation mode from the plurality of resource allocation modes, the method may further include step S505. In step S505, the terminal device receives the assistance information provided (transmitted) by the network device. The assistance information provided by the network device may be beneficial for the terminal device to determine the first resource allocation mode from the plurality of resource allocation modes.

For example, the assistance information provided by the network device may include one or more of the following information: a threshold for evaluating a channel occupancy rate; information related to a resource conflict between the terminal device and another terminal device, where the another terminal device shares resources with the terminal device; statistical information of a first channel, where the first channel is a channel where a resource selectable by the terminal device is located; prediction information of statistical information of a first channel; distribution information of another terminal device that shares resources with the terminal device; or prediction information of distribution information of another terminal device.

In some embodiments, the network device may provide the assistance information to the terminal device before the terminal device determines the first resource allocation mode. In some embodiments, the network device may provide the assistance information to the terminal device before the terminal device transmits the first signal, or during a process in which the terminal device transmits the first signal. However, embodiments of this application are not limited thereto. In some embodiments, the network device may further provide the assistance information to the terminal device using another manner, for example, a periodic manner or an event-triggered manner. For example, the event-triggered manner may refer to that the network device provides updated assistance information to the terminal device again when the assistance information changes (for example, changes significantly).

A manner in which the network device provides assistance information is not limited in embodiments of this application. In some embodiments, these assistance information may be provided to the terminal device using higher-layer signalling (for example, radio resource control (RRC) signalling). In some embodiments, these assistance information may be provided to the terminal device using lower-layer signalling (for example, Layer1/Layer2 (L1/L2) signalling).

In some embodiments, the first information may include a load status of a cell (a current cell) where the terminal device is located. The load status of the cell where the terminal device is located may refer to a quantity of terminal devices in the cell (or network device) where the terminal device is located.

In some embodiments, when there is a relatively small quantity of terminal devices in the cell, the terminal device may tend to select the mode of independent resource selection by the terminal device. This is because a step of negotiating resources between the terminal device and the network device may be omitted in the mode of independent resource selection by the terminal device, thus achieving quick transmission of a wireless signal. In addition, since there are fewer terminal devices in the cell, resource collisions between terminal devices are unlikely to occur and collisions are less likely to occur, thereby ensuring transmission reliability of the wireless signal.

In some embodiments, when there is a relatively large quantity of terminal devices in the cell, the terminal device may tend to select the mode of resource scheduling by a network device, thereby avoiding mutual interference caused by resource collisions.

In other words, the first resource allocation mode may be determined depending on the load of the cell where the terminal device is located, that is, the terminal device may determine the first resource allocation mode based on the load status of the cell where the terminal device is located. In an implementation, if the load of the cell where the terminal device is located is greater than a second threshold, the terminal device determines that the first resource allocation mode is the mode of resource scheduling by a network device; and if the load of the cell where the terminal device is located is less than or equal to the second threshold, the terminal device determines that the first resource allocation mode is the mode of independent resource selection by the terminal device.

In some embodiments, the first resource allocation mode may be determined after the terminal device processes the first information using an artificial intelligence algorithm. For example, after the terminal device obtains the first information, for example, the assistance information provided by the network device, measurement information of a channel obtained by the terminal device, and the local information of the terminal device, the first information may be, as a parameter for the artificial intelligence algorithm, inputted into a corresponding algorithm model, to output the first resource allocation mode.

A specific type of the artificial intelligence algorithm is not limited in embodiments of this application, for example, the artificial intelligence algorithm may be a nonlinear machine learning algorithm, a reinforcement learning algorithm, or the like.

It should be noted that, the terminal device may determine the first resource allocation mode from the plurality of resource allocation modes based on one or more of the first information described above, or a combination thereof.

The terminal device determines the first resource allocation mode from the plurality of resource allocation modes based on the first information, thereby ensuring that the determined first resource allocation mode is more in line with characteristics of a current wireless communications system, and thus achieving higher adaptability.

### Embodiment 2: The First Resource Allocation Mode is Randomly Selected by the Terminal Device.

The terminal device may determine the first resource allocation mode from the plurality of resource allocation modes according to a specific probability, for example, using a random selection manner.

In some embodiments, the terminal device may randomly select the first resource allocation mode during initial uplink synchronization with the network device (for example, when the terminal device is powered on).

In some embodiments, after the terminal device randomly selects the first resource allocation mode, performance achieved using the first resource allocation mode may be evaluated, so that the first resource allocation mode is determined from the plurality of resource allocation modes subsequently based on a performance evaluation result of a historical resource allocation mode.

In embodiments of this application, performance evaluation parameters of the terminal device are not specifically limited, for example, may include a delay in signal transmission, whether a signal transmission status is successful or failed, and a quantity of signal retransmissions.

In some embodiments, the terminal device may always select a mode achieving good performance from the plurality of resource allocation modes based on a performance evaluation result of a historical resource allocation mode, as the first resource allocation mode. In some embodiments, the terminal device may select, in most cases, a mode achieving good performance, or may occasionally select a mode achieving less good performance.

For ease of understanding, the technical solutions in embodiments of this application are described below using several specific examples. The following examples are illustrated by assuming that the terminal device transmits an uplink signal to the network device. However, the technical solutions of this application may also be applied to sidelink signal transmission between terminal devices.

### Example 1: The Terminal Device Randomly Selects the First Resource Allocation Mode.

FIG. 6 is a schematic flowchart of a method for determining a resource allocation mode according to another embodiment of this application. Referring to FIG. 6, the method in FIG. 6 may include step S610 to step S650.

In step S610, a terminal device randomly determines a first resource allocation mode from a plurality of resource allocation modes.

The terminal device may determine the first resource allocation mode from the plurality of resource allocation modes according to a specific probability, for example, determine that the first resource allocation mode is a mode of resource scheduling by a network device, or determine that the first resource allocation mode is a mode of independent resource selection by the terminal device.

In step S620, the terminal device determines a first resource based on the first resource allocation mode, and transmits a first signal using the first resource.

In step S630, the terminal device evaluates performance achieved using the first resource allocation mode based on feedback from the network device.

In some embodiments, the terminal device may determine, based on the feedback from the network device, whether the first signal is successfully transmitted.

In some embodiments, if the first signal is successfully transmitted, the terminal device may further learn specific performance that can be achieved using the first resource allocation mode, for example, a delay in signal transmission.

In step S640, after randomly attempting for a period of time, the terminal device determines a subsequent resource allocation mode.

For example, the terminal device may always select a mode achieving good performance; or the terminal device may select, in most cases, a mode achieving good performance, or may occasionally select a mode achieving less good performance.

In step S650, the terminal device again evaluates performance achieved by the currently used first resource allocation mode.

In some embodiments, if performance achieved by the currently used first resource allocation mode fluctuates greatly, step S610 may be performed, and the first resource allocation mode may be selected again.

### Example 2: The Terminal Device Determines the First Resource Allocation Mode Based on Channel Measurement.

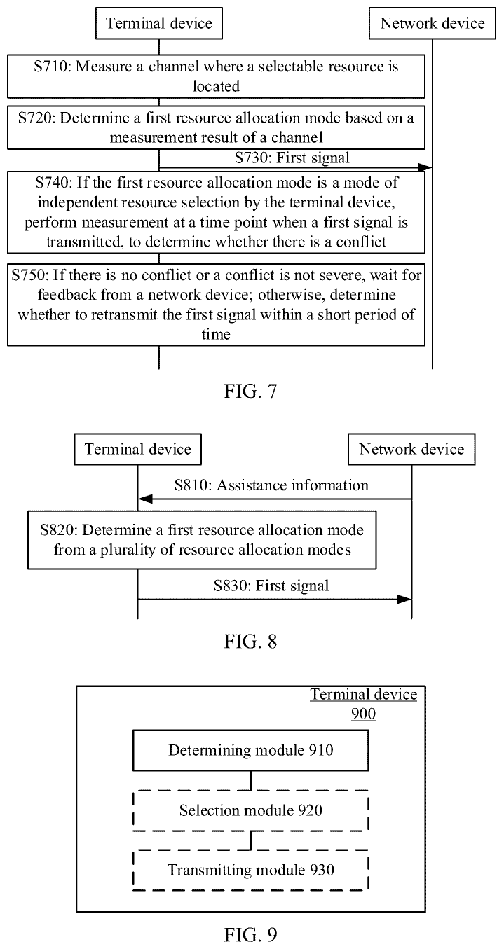

FIG. 7 is a schematic flowchart of a method for determining a resource allocation mode according to still another embodiment of this application. Referring to FIG. 7, the method in FIG. 7 may include step S710 to step S750.

In step S710, a terminal device measures a channel where a resource selectable by the terminal device is located. For example, the terminal device may measure a channel occupancy rate of the channel.

In step S720, the terminal device determines a first resource allocation mode based on a measurement result of the channel.

For example, if the measurement result indicates that the channel occupancy rate of the channel is relatively low, it may be determined that the first resource allocation mode is a mode of independent resource selection by the terminal device. Alternatively, if the measurement result indicates that the channel occupancy rate of the channel is relatively high, it may be determined that the first resource allocation mode is a mode of resource scheduling by a network device.

In step S730, the terminal device determines a first resource based on the first resource allocation mode, and transmits a first signal using the first resource.

In step S740, if the terminal device determines that the first resource allocation mode is the mode of independent resource selection by the terminal device, the terminal device performs, at a time point (for example, a radio frame, a subframe, a slot, or a symbol) when transmitting the first signal, measurement on a bandwidth where a resource used by the terminal device is located, to determine whether there is a conflict with a signal transmitted by another terminal device.

In step S750, if there is no conflict or a conflict is not severe, the terminal device waits for feedback from the network device. If the conflict is severe, the terminal device determines whether to retransmit the first signal within a short period of time.

In some embodiments, if a conflict is severe, the terminal device may choose to retransmit the first signal within a short period of time, for example, retransmit the first signal immediately or before receiving feedback from the network device. In some embodiments, before the terminal device retransmits the first signal, the terminal device may determine, using the mode of independent resource selection by the terminal device again, a resource for retransmitting the first signal. In some embodiments, before the terminal device retransmits the first signal, the terminal device determines, using a new resource allocation mode (for example, the mode of resource scheduling by a network device), a resource for retransmitting the first signal.

### Example 3: The Terminal Device Determines the First Resource Allocation Mode Based on the Assistance Information Provided by the Network Device.

FIG. 8 is a schematic flowchart of a method for determining a resource allocation mode according to still another embodiment of this application. Referring to FIG. 8, the method in FIG. 8 may include step S810 to step S830.

In step S810, a network device transmits assistance information to a terminal device.

The assistance information transmitted by the network device may include one or more of the following information: a threshold for the terminal device to determine a channel occupancy rate; a threshold for determining severity of a conflict between a signal transmitted by the terminal device and a signal transmitted by another terminal device; historical or current statistical information about a channel, such as a channel occupancy rate; prediction information of statistical information of a channel; distribution information of another terminal device that shares resources within a network device (or cell); and prediction information of these distribution information.

In step S820, the terminal device determines a first resource allocation mode based on the assistance information provided by the network device.

In step S830, the terminal device determines a first resource based on the first resource allocation mode, and transmits a first signal using the first resource.

The foregoing describes in detail the method embodiments of this application with reference to FIG. 1 to FIG. 8. The following describes in detail apparatus embodiments of this application with reference to FIG. 9 to FIG. 11. It should be understood that the description of the method embodiments corresponds to the description of the apparatus embodiments, and therefore, for parts that are not described in detail, reference may be made to the foregoing method embodiments.

FIG. 9 is a schematic structural diagram of a terminal device according to an embodiment of this application. The terminal device 900 shown in FIG. 9 may include a determining module 910.

The determining module 910 may be configured to determine a first resource allocation mode from a plurality of resource allocation modes, where the plurality of resource allocation modes include a mode of resource scheduling by a network device and a mode of independent resource selection by the terminal device.

Optionally, the first resource allocation mode is determined by the terminal device based on first information.

Optionally, the first information includes local information of the terminal device and/or assistance information obtained by the terminal device.

Optionally, the first information includes one or more of the following information: assistance information provided by the network device; a measurement result of the terminal device on a first channel, where the first channel is a channel where a resource selectable by the terminal device is located; a status of a load of a cell where the terminal device is located; or a performance evaluation result for a historical resource allocation mode used by the terminal device.

Optionally, the first information includes assistance information provided by the network device, and the assistance information provided by the network device includes one or more of the following information: a threshold for evaluating a channel occupancy rate; information related to a resource conflict between the terminal device and another terminal device, where the another terminal device shares resources with the terminal device; statistical information of a first channel, where the first channel is a channel where a resource selectable by the terminal device is located; prediction information of statistical information of a first channel; distribution information of another terminal device; or prediction information of distribution information of another terminal device.

Optionally, the assistance information is provided by the network device in one or more of the following manners: providing the assistance information to the terminal device before the terminal device determines the first resource allocation mode; periodically providing the assistance information to the terminal device; or providing the assistance information to the terminal device in an event-triggered manner.

Optionally, the first information includes a measurement result of the terminal device on a first channel, the first channel is a channel where a resource selectable by the terminal device is located, and the determining module 910 is further configured to: if the measurement result indicates that a channel occupancy rate of the first channel is greater than a first threshold, determine that the first resource allocation mode is the mode of resource scheduling by a network device; and if the measurement result indicates that a channel occupancy rate of the first channel is less than or equal to the first threshold, determine that the first resource allocation mode is a mode of independent resource selection by the terminal device.

Optionally, the first information includes a status of a load of a cell where the terminal device is located, and the determining module 910 is further configured to: if the load of the cell where the terminal device is located is greater than a second threshold, determine that the first resource allocation mode is the mode of resource scheduling by a network device; and if the load of the cell where the terminal device is located is less than or equal to the second threshold, determine that the first resource allocation mode is a mode of independent resource selection by the terminal device.

Optionally, the first resource allocation mode is determined after the terminal device processes the first information using an artificial intelligence algorithm.

Optionally, the first resource allocation manner is randomly selected by the terminal device.

Optionally, the terminal device 900 includes: a selection module 920, configured to select a first resource using the first resource allocation mode; and a transmitting module 930, configured to transmit a first signal using the first resource.

Optionally, the first signal is retransmitted using a hybrid automatic repeat request HARQ manner, and a resource allocation mode for retransmitting the first signal using the HARQ manner is the same as or different from a resource allocation mode for an initial transmission of the first signal.

Optionally, resources determined using the first resource allocation mode include one or more of the following resources: an uplink communication resource, or a sidelink communication resource.

Optionally, the mode of resource scheduling by a network device includes a dynamic scheduling mode and/or a semi-persistent scheduling mode.

Optionally, a resource determined using the mode of independent resource selection by the terminal device is selected by the terminal device from a resource pool, and the resource pool is configured and broadcasted by the network device, or pre-configured for the terminal device.

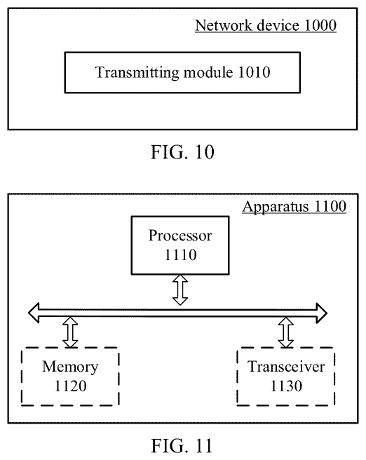

FIG. 10 is a schematic structural diagram of a network device according to an embodiment of this application. The network device 1000 shown in FIG. 10 may include a transmitting module 1010.

The transmitting module 1010 may be configured to transmit assistance information to a terminal device, where the assistance information is used for the terminal device to determine a first resource allocation mode from a plurality of resource allocation modes, where the plurality of resource allocation modes include a mode of resource scheduling by a network device and a mode of independent resource selection by the terminal device.

Optionally, the assistance information includes one or more of the following information: a threshold for evaluating a channel occupancy rate; information related to a resource conflict between the terminal device and another terminal device, where the another terminal device shares resources with the terminal device; statistical information of a first channel, where the first channel is a channel where a resource selectable by the terminal device is located; prediction information of statistical information of a first channel; distribution information of another terminal device; or prediction information of distribution information of another terminal device.

Optionally, the assistance information is provided by the network device in one or more of the following manners: providing the assistance information to the terminal device before the terminal device determines the first resource allocation mode; periodically providing the assistance information to the terminal device; or providing the assistance information to the terminal device in an event-triggering manner.

Optionally, resources determined using the first resource allocation mode include one or more of the following resources: an uplink communication resource, or a sidelink communication resource.

Optionally, the mode of resource scheduling by a network device includes a dynamic scheduling mode and/or a semi-persistent scheduling mode.

Optionally, a resource determined using the mode of independent resource selection by the terminal device is selected by the terminal device from a resource pool, and the resource pool is configured and broadcasted by the network device, or pre-configured for the terminal device.

FIG. 11 is a schematic diagram of a structure of a communications apparatus according to an embodiment of this application. The dashed lines in FIG. 11 indicate that the unit or module is optional. The apparatus 1100 may be configured to implement the method described in the foregoing method embodiments. The apparatus 1100 may be a chip, a terminal device, or a network device.

The apparatus 1100 may include one or more processors 1110. The processor 1110 may allow the apparatus 1100 to implement the method described in the foregoing method embodiments. The processor 1110 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 1100 may further include one or more memories 1120. The memory 1120 stores a program that may be executed by the processor 1110 to cause the processor 1110 to perform the method described in the foregoing method embodiments. The memory 1120 may be independent of the processor 1110 or may be integrated into the processor 1110.

The apparatus 1100 may further include a transceiver 1130. The processor 1110 may communicate with another device or chip through a transceiver 1130. For example, the processor 1110 may transmit data to and receive data from the another device or chip through the transceiver 1130.

An embodiment of this application further provides a computer-readable storage medium for storing a program. The computer-readable storage medium may be applied to the terminal or the network device provided in embodiments of this application, and the program causes a computer to perform the methods performed by the terminal or the network device in various embodiments of this application.

An embodiment of this application further provides a computer program product. The computer program product includes a program. The computer program product may be applied to the terminal or the network device provided in embodiments of this application, and the program causes a computer to perform the methods performed by the terminal or the network device in various embodiments of this application.

An embodiment of this application further provides a computer program. The computer program may be applied to the terminal or the network device provided in embodiments of this application, and the computer program causes a computer to perform the methods performed by the terminal or the network device in various embodiments of this application.

It should be understood that the terms “system” and “network” in this application may be used interchangeably. In addition, the terms used in this application are only used to illustrate specific embodiments of this application, but are not intended to limit this application. The terms “first”, “second”, “third”, “fourth”, and the like in the specification, claims, and accompanying drawings of this application are used for distinguishing different objects from each other, rather than defining a specific order. In addition, the terms “include” and “have” and any variations thereof are intended to cover a non-exclusive inclusion.

In embodiments of this application, “indicate” mentioned herein may refer to a direct indication, or may refer to an indirect indication, or may mean that there is an association relationship. For example, A indicates B, which may mean that A directly indicates B, for example, B may be obtained by means of A; or may mean that A indirectly indicates B, for example, A indicates C, and B may be obtained by means of C; or may mean that there is an association relationship between A and B.

In embodiments of this application, “B corresponding to A” means that B is associated with A, and B may be determined based on A. However, it should also be understood that, determining B based on A does not mean determining B based only on A, but instead B may be determined based on A and/or other information.

In embodiments of this application, the term “corresponding” may mean that there is a direct or indirect correspondence between two elements, or that there is an association between two elements, or that there is a relationship of “indicating” and “being indicated”, “configuring” and “being configured”, or the like.

In embodiments of this application, the “predefined” or “pre-configured” may be implemented by pre-storing corresponding code, tables, or other forms that may be used to indicate related information in devices (for example, including a terminal device and a network device), and a specific implementation thereof is not limited in this application. For example, predefining may indicate being defined in a protocol.

In embodiments of this application, the “protocol” may indicate a standard protocol in the communications field, which may include, for example, an LTE protocol, an NR protocol, and a related protocol applied to a future communications system. This is not limited in this application.

In embodiments of this application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that, the disclosed system, apparatus, and method may be implemented in other manners. For example, the described apparatus embodiment is merely an example. For example, division into the units is merely logical function division and may be other division during actual implementation. For example, a plurality of units or components may be combined or integrated into another system, or some features may be ignored or not performed. In addition, the displayed or discussed mutual couplings or direct couplings or communications connections may be implemented as indirect couplings or communications connections through some interfaces, apparatuses or units, and may be implemented in electrical, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objective of the solutions of the embodiments.

In addition, function units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A method for determining a resource allocation mode, comprising:
determining, by a terminal device, a first resource allocation mode from a plurality of resource allocation modes,
wherein the plurality of resource allocation modes comprise a mode of resource scheduling by a network device and a mode of independent resource selection by the terminal device.

2. The method according to claim 1, wherein the first resource allocation mode is determined by the terminal device based on first information;
wherein the first information comprises local information of the terminal device and/or assistance information obtained by the terminal device.

3. The method according to claim 2, wherein the first information comprises one or more of following information:
assistance information provided by the network device;
a measurement result of the terminal device on a first channel, wherein the first channel is a channel where a resource selectable by the terminal device is located;
a status of a load of a cell where the terminal device is located; or
a performance evaluation result for a historical resource allocation mode used by the terminal device.

4. The method according to claim 2, wherein the first information comprises assistance information provided by the network device, and the assistance information provided by the network device comprises one or more of following information:
a threshold for evaluating a channel occupancy rate;
information related to a resource conflict between the terminal device and another terminal device, wherein the another terminal device shares resources with the terminal device;
statistical information of a first channel, wherein the first channel is a channel where a resource selectable by the terminal device is located;
prediction information of statistical information of a first channel;
distribution information of another terminal device; or
prediction information of distribution information of another terminal device.

5. The method according to claim 3, wherein the assistance information is provided by the network device in one or more of following manners:
providing the assistance information to the terminal device before the terminal device determines the first resource allocation mode;
periodically providing the assistance information to the terminal device; or
providing the assistance information to the terminal device in an event-triggering manner.

6. The method according to claim 2, wherein the first information comprises a measurement result of the terminal device on a first channel, the first channel is a channel where a resource selectable by the terminal device is located, and the determining, by a terminal device, a first resource allocation mode from a plurality of resource allocation modes comprises:
if the measurement result indicates that a channel occupancy rate of the first channel is greater than a first threshold, determining, by the terminal device, that the first resource allocation mode is the mode of resource scheduling by the network device; or
if the measurement result indicates that a channel occupancy rate of the first channel is less than or equal to the first threshold, determining, by the terminal device, that the first resource allocation mode is the mode of independent resource selection by the terminal device;
or wherein the first information comprises a status of a load of a cell where the terminal device is located, and the determining, by a terminal device, a first resource allocation mode from a plurality of resource allocation modes comprises:
if the load of the cell where the terminal device is located is greater than a second threshold, determining, by the terminal device, that the first resource allocation mode is the mode of resource scheduling by the network device; or
if the load of the cell where the terminal device is located is less than or equal to the second threshold, determining, by the terminal device, that the first resource allocation mode is the mode of independent resource selection by the terminal device.

7. The method according to claim 2, wherein the first resource allocation mode is determined by the terminal device by processing the first information using an artificial intelligence algorithm.

8. The method according to claim 1, wherein the first resource allocation mode is randomly selected by the terminal device.

9. The method according to claim 1, wherein the method further comprises:
selecting, by the terminal device, a first resource using the first resource allocation mode; and
transmitting, by the terminal device, a first signal using the first resource.

10. A terminal device, comprising a memory and a processor, wherein the memory is configured to store computer programs, and the processor is configured to execute the computer programs stored in the memory to cause the terminal device to perform an operation of:
determining a first resource allocation mode from a plurality of resource allocation modes,
wherein the plurality of resource allocation modes comprise a mode of resource scheduling by a network device and a mode of independent resource selection by the terminal device.

11. The terminal device according to claim 10, wherein the first resource allocation mode is determined by the terminal device based on first information;
wherein the first information comprises local information of the terminal device and/or assistance information obtained by the terminal device.

12. The terminal device according to claim 11, wherein the first information comprises one or more of following information:
assistance information provided by the network device;
a measurement result of the terminal device on a first channel, wherein the first channel is a channel where a resource selectable by the terminal device is located;
a status of a load of a cell where the terminal device is located; or
a performance evaluation result for a historical resource allocation mode used by the terminal device.

13. The terminal device according to claim 11, wherein the first information comprises assistance information provided by the network device, and the assistance information provided by the network device comprises one or more of following information:
a threshold for evaluating a channel occupancy rate;
information related to a resource conflict between the terminal device and another terminal device, wherein the another terminal device shares resources with the terminal device;
statistical information of a first channel, wherein the first channel is a channel where a resource selectable by the terminal device is located;
prediction information of statistical information of a first channel;
distribution information of another terminal device; or
prediction information of distribution information of another terminal device.

14. The terminal device according to claim 12, wherein the assistance information is provided by the network device in one or more of following manners:
providing the assistance information to the terminal device before the terminal device determines the first resource allocation mode;
periodically providing the assistance information to the terminal device; or
providing the assistance information to the terminal device in an event-triggering manner.

15. The terminal device according to claim 11, wherein the first information comprises a measurement result of the terminal device on a first channel, the first channel is a channel where a resource selectable by the terminal device is located, and the terminal device is further configured to:
if the measurement result indicates that a channel occupancy rate of the first channel is greater than a first threshold, determine that the first resource allocation mode is the mode of resource scheduling by the network device; or
if the measurement result indicates that a channel occupancy rate of the first channel is less than or equal to the first threshold, determine that the first resource allocation mode is a mode of independent resource selection by the terminal device;
or wherein the first information comprises a status of a load of a cell where the terminal device is located, and the terminal device is further configured to:
if the load of the cell where the terminal device is located is greater than a second threshold, determine that the first resource allocation mode is the mode of resource scheduling by the network device; or
if the load of the cell where the terminal device is located is less than or equal to the second threshold, determine that the first resource allocation mode is the mode of independent resource selection by the terminal device.

16. The terminal device according to claim 11, wherein the first resource allocation mode is determined by the terminal device by processing the first information using an artificial intelligence algorithm.

17. The terminal device according to claim 10, wherein the first resource allocation mode is randomly selected by the terminal device.

18. The terminal device according to claim 10, the terminal device is further configured to: select a first resource using the first resource allocation mode; and
transmit a first signal using the first resource.

19. A network device, comprising a memory and a processor, wherein the memory is configured to store computer programs, and the processor is configured to execute the computer programs stored in the memory to cause the network device to perform an operation of:
transmitting assistance information to a terminal device, wherein the assistance information is used for the terminal device to determine a first resource allocation mode from a plurality of resource allocation modes,
wherein the plurality of resource allocation modes comprise a mode of resource scheduling by a network device and a mode of independent resource selection by the terminal device.

20. The network device according to claim 19, wherein the assistance information comprises one or more of following information:
a threshold for evaluating a channel occupancy rate;
information related to a resource conflict between the terminal device and another terminal device, wherein the another terminal device shares resources with the terminal device;
statistical information of a first channel, wherein the first channel is a channel where a resource selectable by the terminal device is located;
prediction information of statistical information of a first channel;
distribution information of another terminal device; or
prediction information of distribution information of another terminal device.
